(19) United States
(12) Patent Application Publication
(10) Pub. No.: US 2026/0087778 A1
(43) Pub. Date: Mar. 26, 2026

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventors: Takaya MIYAMOTO, Tokyo (JP); Akinori EBIHARA, Tokyo (JP); Taiki MIYAGAWA, Tokyo (JP)

(73) Assignee: NEC Corporation, Tokyo (JP)

(21) Appl. No.: 19/326,945

(22) Filed: Sep. 12, 2025

(30) Foreign Application Priority Data
Sep. 20, 2024 (JP) 2024-164028

(51) Int. Cl. G06V 10/764; G06V 10/62; G06V 10/74

(52) U.S. Cl. CPC G06V 10/764; G06V 10/62; G06V 10/761

(57) ABSTRACT

An information processing apparatus includes, an acquisition unit that acquires time-series image data; an index calculation unit that calculates an integrated feature quantity or a score, the integrated feature quantity being obtained by integrating a first feature quantity and a second feature quantity, the score indicating a degree of similarity between the first feature quantity and the second feature quantity, a likelihood ratio calculation unit that calculates a likelihood ratio indicating a likelihood of a class to which the time-series image data belong, based on the integrated feature quantity or the score, and a determination unit that determines that the time-series image data belong to a registered class in a case where the likelihood ratio reaches a class threshold, and determines that the time-series image data do not belong to any registered class in a case where the likelihood ratio reaches an unregistration threshold without reaching the class threshold.

### INCORPORATION BY REFERENCE

This application is based upon and claims the benefit of priority from Japanese Patent Application No. 2024-164028, filed on September 20, 2024, the disclosure of which is incorporated herein in its entirety by reference.

### TECHNICAL FIELD

Example embodiments of a present disclosure relate to an information processing apparatus, an information processing method, and a non-transitory recording medium.

### BACKGROUND ART

A known apparatus of this type performs processing of determining a class to which data belong (so-called class classification). For example, International Publication No. WO2021/229663 discloses a technology/technique of determining a class to which series data serving as a classification target belong, in a case where an individual score or an integrated score calculated based on a likelihood ratio reaches a predetermined threshold.

### SUMMARY

It is an example object of the present disclosure to provide an information processing apparatus, an information processing method, and a non-transitory recording medium for improving the technology disclosed in the background art.

An information processing apparatus according to an example aspect of the present disclosure includes: an acquisition unit that acquires time-series image data; an index calculation unit that calculates an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; a likelihood ratio calculation unit that calculates a likelihood ratio indicating a likelihood of a class to which the time-series image data belong, based on the integrated feature quantity or the score; and a determination unit that determines that the time-series image data belong to a registered class corresponding to the registered image data in a case where the likelihood ratio reaches a class threshold, and determines that the time-series image data do not belong to any registered class in a case where the likelihood ratio reaches an unregistration threshold without reaching the class threshold.

An information processing method according to an example aspect of the present disclosure is an information processing method that is executed by at least one computer, the information processing including: acquiring time-series image data; calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; calculating a likelihood ratio indicating a likelihood of a class to which the time-series image data belong, based on the integrated feature quantity or the score; and determining that the time-series image data belong to a registered class corresponding to the registered image data in a case where the likelihood ratio reaches a class threshold, and determining that the time-series image data do not belong to any registered class in a case where the likelihood ratio reaches an unregistration threshold without reaching the class threshold.

A non-transitory recording medium according to an example aspect of the present disclosure is a non-transitory recording medium on which a computer program that allows at least one computer to execute an information processing method is recorded, the information processing method including: acquiring time-series image data; calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; calculating a likelihood ratio indicating a likelihood of a class to which the time-series image data belong, based on the integrated feature quantity or the score; and determining that the time-series image data belong to a registered class corresponding to the registered image data in a case where the likelihood ratio reaches a class threshold, and determining that the time-series image data do not belong to any registered class in a case where the likelihood ratio reaches an unregistration threshold without reaching the class threshold.

### BRIEF DESCRIPTION OF THE DRAWINGS

FIG. 1 is a block diagram illustrating a hardware configuration of a first information processing apparatus;

FIG. 2 is a block diagram illustrating a functional configuration of the first information processing apparatus;

FIG. 3 is a flowchart illustrating a flow of operation of the first information processing apparatus;

FIG. 4 is version 1 of a graph illustrating an example of a likelihood ratio calculated by the first information processing apparatus;

FIG. 5 is version 2 of a graph illustrating an example of the likelihood ratio calculated by the first information processing apparatus;

FIG. 6 is a block diagram illustrating a functional configuration of a second information processing apparatus;

FIG. 7 is a flowchart illustrating a flow of operation of the second information processing apparatus;

FIG. 8 is a graph illustrating an example of changing an unregistration threshold in the second information processing apparatus;

FIG. 9 is version 1 of a graph illustrating an example of changing the unregistration threshold and a class threshold in the second information processing apparatus;

FIG. 10 is version 2 of a graph illustrating an example of changing the unregistration threshold and the class threshold in the second information processing apparatus;

FIG. 11 is a block diagram illustrating a functional configuration of a third information processing apparatus;

FIG. 12 is a flowchart illustrating a flow of operation of the third information processing apparatus;

FIG. 13 is a block diagram illustrating a functional configuration of a fourth information processing apparatus;

FIG. 14 is a flowchart illustrating a flow of operation of the fourth information processing apparatus;

FIG. 15 is version 1 of a graph illustrating an example of the likelihood ratio calculated by the first information processing apparatus; and

FIG. 16 is version 2 of a graph illustrating an example of the likelihood ratio calculated by the first information processing apparatus.

### EXAMPLE EMBODIMENTS

Hereinafter, an information processing apparatus, an information processing method, a computer program, and a recording medium according to example embodiments will be described with reference to the drawings.

### First Example Embodiment

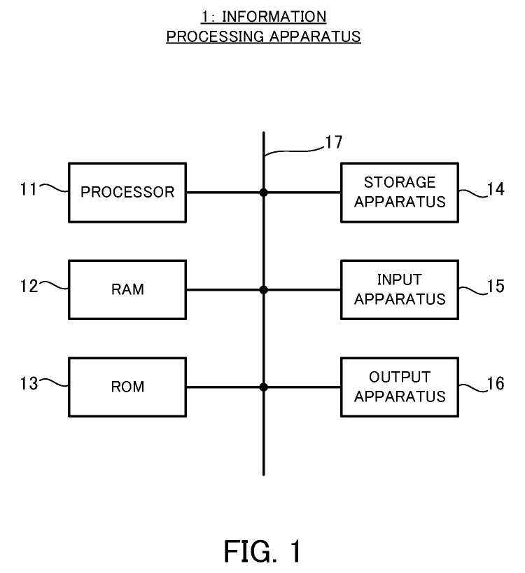

A first information processing apparatus will be described with reference to FIG. 1 to FIG. 5.

### Hardware Configuration

First, with reference to FIG. 1, a hardware configuration of the first information processing apparatus will be described. FIG. 1 is a block diagram illustrating the hardware configuration of the first information processing apparatus.

As illustrated in FIG. 1, a first information processing apparatus 1 includes a processor 11, a RAM (Random Access Memory) 12, a ROM (Read Only Memory) 13, a storage apparatus 14, an input apparatus 15, and an output apparatus 16. The processor 11, the RAM 12, the ROM 13, the storage apparatus 14, the input apparatus 15, and the output apparatus 16 described above are connected via a data bus 17. The data bus 17 may be an interface other than a data bus (e.g., a LAN, a USB, etc.).

The processor 11 reads a computer program. For example, the processor 11 is configured to read a computer program stored in at least one of the RAM 12, the ROM 13, and the storage apparatus 14. Alternatively, the processor 11 may read a computer program stored on a computer-readable recording medium, by using a not-illustrated recording medium reading apparatus. The processor 11 may acquire (i.e., read) a computer program from a not-illustrated apparatus disposed outside the first information processing apparatus 1 via a network interface. The processor 11 performs various types of processing by executing the read computer program. When the processor 11 executes the read computer program, a function block related to processing to be performed by the first information processing apparatus 1 is realized in the processor 11. That is, the processor 11 may function as a controller that performs various types of processing and control in the first information processing apparatus 1.

The processor 11 may be configured as, for example, a CPU (Central Processing Unit), a GPU (Graphics Processing Unit), a FPGA (Field-Programmable Gate Array), a DSP (Digital Signal Processor), an ASIC (Application Specific Integrated Circuit), or a quantum processor. The processor 11 may be configured by using one of them, or a plurality of them in parallel.

The RAM 12 temporarily stores the computer program to be executed by processor 11. The RAM 12 temporarily stores data that are temporarily used by the processor 11 when the processor 11 is executing the computer program. The RAM 12 may be, for example, a D-RAM (Dynamic Random Access Memory) or a SRAM (Static Random Access Memory). In addition, another type of volatile memory may be used in place of the RAM 12.

The ROM 13 stores the computer program to be executed by the processor 11. The ROM 13 may also store other fixed data. The ROM 13 may be, for example, a P-ROM (Programmable Read Only Memory) or an EPROM (Erasable Read Only Memory). In addition, another type of nonvolatile memory may be used in place of the ROM 13.

The storage apparatus 14 stores data that are stored by the first information processing apparatus 1 for a long time. The storage apparatus 14 may operate as a transitory storage apparatus of the processor 11. The storage apparatus 14 may store the computer program to be executed by the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the first information processing apparatus 1. The input apparatus 15 may include, for example, at least one of a keyboard, a mouse, a touch panel, and a touch pen. The input apparatus 15 may be an apparatus that allows audio input/voice input, including a microphone, for example.

The output apparatus 16 is an apparatus that outputs information about the first information processing apparatus 1 to the outside. For example, the output apparatus 16 may be a display apparatus (e.g., a display, a monitor, etc.) that is configured to display the information about the first information processing apparatus 1. The output apparatus 16 may also be a speaker that audio-outputs the information about the first information processing apparatus 1, or the like.

The first information processing apparatus may be configured to include only a part of each component described in FIG. 1. For example, the first information processing apparatus 1 may be configured to include only the processor 11, the RAM 12, and the ROM 13 of the above-described components. In this case, each of the storage apparatus 14, the input apparatus 15, and the output apparatus 16 may be provided as an apparatus external to the first information processing apparatus 1. In addition, a part of an arithmetic function of the first information processing apparatus 1 may be realized by an external server, a cloud, or the like.

### Functional Configuration

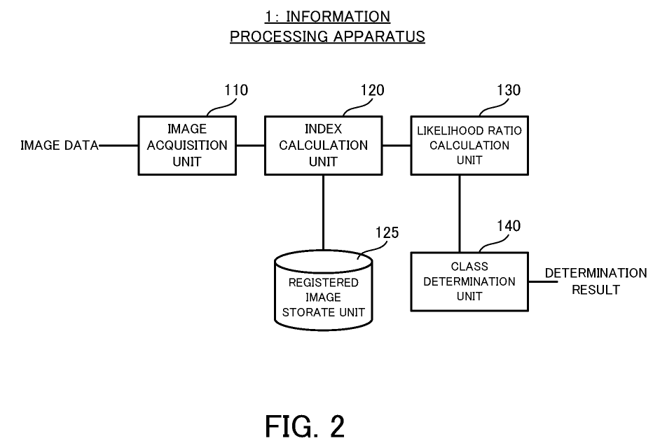

Next, with reference to FIG. 2, a functional configuration of the first information processing apparatus 1 will be described. FIG. 2 is a block diagram illustrating the functional configuration of the first information processing apparatus.

In FIG. 2, the first information processing apparatus 1 is configured as an apparatus that classifies inputted series data. More specifically, the first information processing apparatus 1 is configured to perform matching/verification processing (in other words, authentication processing) of a target included in image data, by classifying inputted time-series image data into a class corresponding to registered image data. The first information processing apparatus 1 includes, as components for realizing its functions, an image acquisition unit 110, an index calculation unit 120, a registered image storage unit 125, a likelihood ratio calculation unit 130, and a class determination unit 140. Each of the image acquisition unit 110, the index calculation unit 120, the likelihood ratio calculation unit 130, and the class determination unit 140 may be a processing block realized by the processor 11 described above (see FIG. 1).

The image acquisition unit 110 is configured to acquire time-series image data. The image acquisition unit 110 may sequentially acquire a plurality of frames of image data. For example, the image acquisition unit 110 may be configured to acquire an image at each frame captured, from a camera that captures a video. The time-series image data acquired by the image acquisition unit 110 are acquired in order to perform the matching processing to registered image data registered in advance. For example, the time-series image data may be face image data including a face of the target. In this case, the acquired face image data may be used to perform face authentication/facial recognition using the face of the target. The face image data are merely an example, and the time-series image data may be image data including a part other than the face of the target (e.g., fingerprints, an iris, etc.). The time-series image data may also include a target other than a person. The time-series image data acquired by the image acquisition unit 110 are outputted to the index calculation unit 120.

The index calculation unit 120 is configured to calculate an integrated feature quantity or a score from the time-series image data acquired by the image acquisition unit 110. The integrated feature quantity is a feature quantity obtained by integrating a first feature quantity that is a feature quantity of the time-series image data and a second feature quantity that is a feature quantity of the registered image data registered in advance. The score indicates a degree of similarity (in other words, a degree of matching) between the first feature quantity and the second feature quantity described above. The index calculation unit 120 may have a function of extracting a feature quantity from the image data in order to calculate the integrated feature quantity or score. For example, the index calculation unit 120 may have a function of extracting a feature quantity of the face of the target from the face image data including the face of the target. The index calculation unit 120 acquires the time-series image data from the image acquisition unit 110, while acquiring the registered image data from the registered image storage unit 125, thereby to calculate the integrated feature quantity or score. The integrated feature quantity or score calculated by the index calculation unit 120 is outputted to the likelihood ratio calculation unit 130.

The registered image storage unit 125 is configured to store the registered image data to be used by the index calculation unit 120 when calculating the integrated feature quantity or score. The registered image storage unit 125 may be configured to store the feature quantity extracted from the registered image data (i.e., the second feature quantity) rather than the registered image data itself. The registered image storage section 125 may be realized by using the storage apparatus 14 described above (see FIG. 1). Alternatively, the registered image storage section 125 may be realized by a database or the like provided outside the first information processing apparatus 1. The registered image storage unit 125 may be configured to store a plurality of pieces of registered image data. In this case, the index calculation unit 120 may calculate N integrated feature quantities or N scores by using the first feature quantity extracted from the time-series image data and N second feature quantities respectively extracted from N pieces of registered image data. The registered image data stored in the registered image storage unit 125 may be, for example, the face image data on a registered user to be used for face authentication/facial recognition. In this case, the integrated feature quantity and the score calculated by the index unit 120 are indices indicating a degree of matching between the face of the target included in the time-series image data and the face of the registered user.

The likelihood ratio calculation unit 130 is configured to calculate a likelihood ratio, based on the integrated feature quantity or score calculated by the index calculation unit 120. The likelihood ratio calculated by the likelihood ratio calculation unit 130 is a value indicating the likelihood of a class to which the time-series image data belong. For example, the likelihood ratio may be a value indicating the likelihood that the time-series image data belong to each of a plurality of registered classes set for respective pieces of registered image data. In this case, the likelihood ratio calculation unit 130 may calculate a plurality of likelihood ratios respectively corresponding to the plurality of registered classes (i.e., the same number of likelihood ratios as the number of the registered classes). For example, in a case where N pieces of registered image data are registered in the registered image storage unit 125, N registered classes corresponding to them may be set, and the likelihood ratio calculation unit 130 may calculate N likelihood ratios respectively corresponding to the N registered classes. A specific method used by the likelihood ratio calculation unit 130 to calculate the likelihood ratio is not particularly limited. The likelihood ratio calculation unit 130 may calculate the likelihood ratio by using various existing methods. For example, the likelihood ratio calculation unit 130 may calculate the likelihood ratio by using an estimation model that is machine-learned in advance (specifically, a neural network learned by deep learning, etc.). The likelihood ratio calculation unit 130 may calculate the likelihood ratio based on two or more consecutive pieces of image data of the time-series image data. For example, the likelihood ratio calculation unit 130 may calculate the likelihood ratio by using the integrated feature quantity or score calculated from the image data acquired in the past, in addition to the integrated feature quantity or score calculated from the image data acquired immediately before. The likelihood ratio calculated by the likelihood ratio calculation unit 130 is outputted to the class determination unit 140.

The class determination unit 140 is configured to determine the class to which the time-series image data belong, based on the likelihood ratio calculated by the likelihood ratio calculation unit 130. That is, the class determination unit 140 is configured to perform class classification processing based on the likelihood ratio. Specifically, the class determination unit 140 determines that the time-series image data belong to the registered class corresponding to the registered image data in a case where the likelihood ratio reaches a class threshold set in advance. That is, the class determination unit 140 determines that the time-series image data match any one of the pieces of registered image data. Here, the class threshold is a threshold for determining that the likelihood ratio is high enough to determine that the time-series image data belong to the registered class. On the other hand, the class determination unit 140 determines that the time-series image data do not belong to any registered class in a case where the likelihood ratio reaches an unregistration threshold without reaching the class threshold. That is, the class determination unit 140 determines that the time-series image data do not match any one of the pieces of registered image data (in other words, they are unregistered). The unregistration threshold here is a threshold set in advance to determine that the time-series image data do not belong to any registered class. A specific example of the unregistration threshold will be described in detail later.

### Flow of Operation

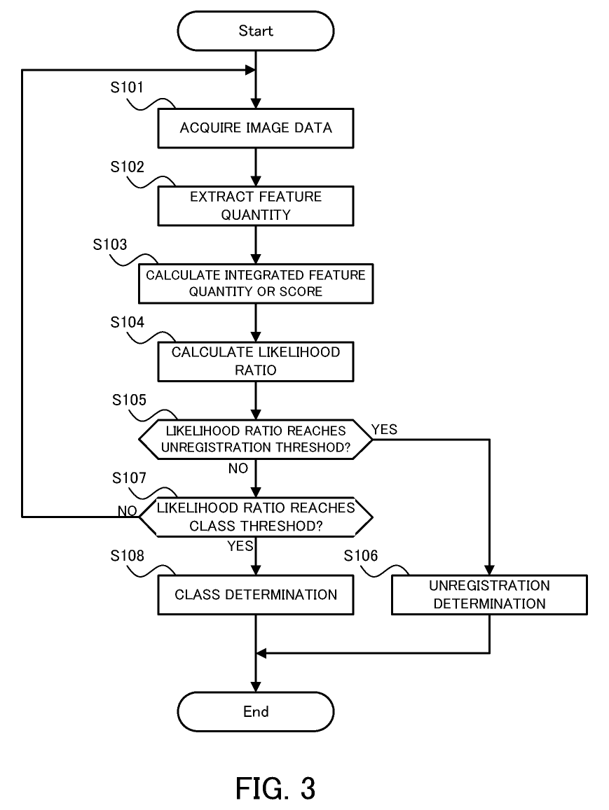

Next, with reference to FIG. 3, a flow of operation of the first information processing apparatus 1 will be described. FIG. 3 is a flowchart illustrating the flow of the operation of the first information processing apparatus.

As illustrated in FIG. 3, when the operation of the first information processing apparatus 1 is started, first, the image acquisition unit 110 acquires the image data (step S101). The image data acquired here may be most recently captured one frame of image data of the time-series image data.

Then, the index calculation unit 120 extracts the first feature quantity from the image data acquired by the image acquisition unit 110 and extracts the second feature quantity from the registered image data read from the registered image storage unit 125 (step S102). Then, the index calculation unit 120 calculates the integrated feature quantity or score, based on the extracted first feature quantity and second feature quantity (step S103).

Then, the likelihood ratio calculation unit 130 calculates the likelihood ratio indicating the likelihood of the class to which the time-series image data belong, based on the integrated feature quantity or score calculated by the index calculation unit 120 (step S104).

Then, the class determination unit 140 determines whether or not the likelihood ratio calculated by the likelihood ratio calculation unit 130 reaches the unregistration threshold (step S105). In a case where the likelihood ratio reaches the unregistration threshold (step S105: YES), the class determination unit 140 determines that the time-series image data do not belong to any registered class (i.e., they are unregistered) (step S106). In this case, it is determined that the time-series image data do not match the registered image data (in other words, the target is an unregistered user), and the matching processing is ended.

On the other hand, in a case where the likelihood ratio does not reach the unregistration threshold (step S105: NO), the class determination unit 140 determines whether or not the likelihood ratio reaches the class threshold (step S107). In a case where the likelihood ratio reaches the class threshold (step S107: YES), the class determination unit 140 determines that the time-series image data belong to the registered class (step S108). Specifically, the class determination unit 140 determines that the time-series image data belong to the registered class corresponding to the likelihood ratio that exceeds the class threshold. In this case, it is determined that the time-series image data match the registered image data (in other words, the target is a registered user), and the matching processing is ended.

On the other hand, in a case where the likelihood ratio does not reach the class threshold (step S107: NO), the processing is started again from the step S101. That is, the image data acquisition unit 110 acquires new image data (e.g., a next frame of image data), and the aforementioned series of processing steps are performed again. By repeating the processing as described above, the likelihood ratio calculated by the likelihood ratio calculation unit 130 gradually changes. Then, the determination processing (i.e., the matching processing) is continued until the likelihood ratio exceeds the class threshold or the unregistration threshold.

The first information processing apparatus 1 may be configured to perform various types of processing related to the target, based on a determination result of the class determination unit 140. For example, the first information processing apparatus 1 may be configured to perform processing of permitting or prohibiting passage of the target through a predetermined area, based on the determination result of the class determination unit 140. More specifically, in a case where the time-series image data are determined to match the registered image data, the first information processing apparatus 1 may control a gate disposed in a predetermined area to open, thereby permitting the target to pass through. In addition, in a case where it is determined that the time-series image data do not match the registered image data (i.e., they are unregistered), the first information processing apparatus 1 may control the gate disposed in the predetermined area to close, thereby prohibit the target from passing through.

### Operation Example

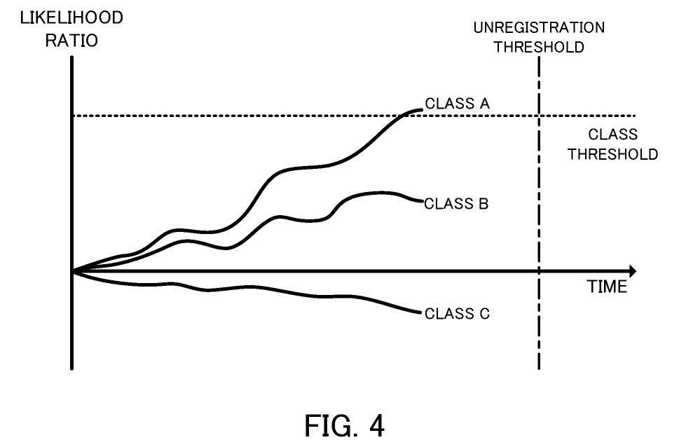

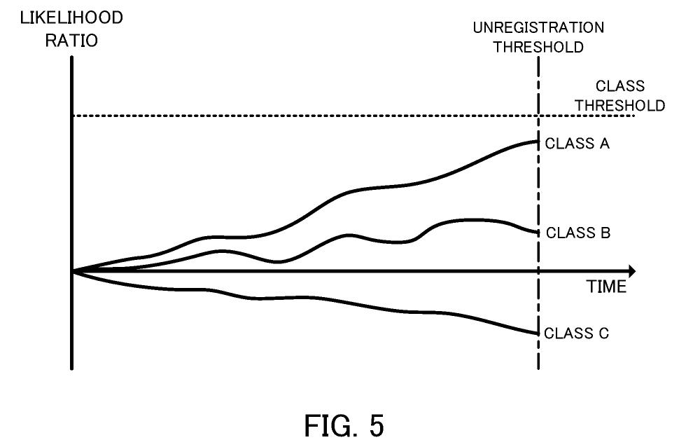

Next, with reference to FIG. 4 and FIG. 5, a specific operation example of the first information processing apparatus 1 (in particular, an example of an operation of determining the class to which time-series image data belong, based on the likelihood ratio) will be described. FIG. 4 is version 1 of a graph illustrating an example of the likelihood ratio calculated by the first information processing apparatus. FIG. 5 is version 2 of a graph illustrating an example of the likelihood ratio calculated by the first information processing apparatus.

In the examples illustrated in FIG. 4 and FIG. 5, registered image data A, registered image data B, and registered image data C are registered as the registered image data. Then, a class A, a class B, and a class C are set as registered classes respectively corresponding to the registered image data A, B, and C.

The likelihood ratio calculation unit 130 calculates respective likelihood ratios, based on the image data acquired by the image acquisition unit 110 and the registered image data A, B, and C. That is, the likelihood ratio calculation unit 130 calculates a first likelihood ratio corresponding to the class A, a first likelihood ratio corresponding to the class B, and a first likelihood ratio corresponding to the class C. These likelihood ratios gradually change over time (i.e., as the image data are sequentially acquired).

Here, in particular, the class threshold is set in a height direction of the likelihood ratio. Therefore, in a case where the likelihood ratio that changes over time becomes sufficiently high, it reaches the class threshold. On the other hand, the unregistration threshold is set in a time direction of the likelihood ratio. Therefore, in a case where a certain period of time passes without the likelihood ratio exceeding the class threshold, it reaches the unregistration threshold.

In the example illustrated in FIG. 4, the likelihood ratio corresponding to the class A reaches the class threshold. On the other hand, the likelihood ratios corresponding to the classes B and C do not reach the class threshold. In such a case, the time-series image data acquired by the image acquisition unit 110 are determined to belong to the class A. That is, the time-series image data are determined to match the registered image data A and not to match the registered image data B and C. As a result, obtained is such a matching result that the target included in the time-series image data is a user corresponding to the registered image data A.

On the other hand, in the example illustrated in FIG. 5, all of the likelihood ratios corresponding to the classes A, B, and C reach the unregistration threshold without reaching the class threshold. In such a case, the time-series image data acquired by the image acquisition unit 110 are determined to belong to none of the classes A, B, and C. That is, the time-series image data are determined to be unregistered image data that do not match any one of the registered image data A, B, and C. As a result, obtained is such a matching result that the target included in the time-series image data is an unregistered user.

### Technical Effect

Next, a technical effect obtained by the first information processing apparatus 1 will be described.

As described in FIG. 1 to FIG. 5, in the first information processing apparatus 1, it is determined whether the time-series image data are registered by using the class threshold, while it is determined whether the time-series image data are unregistered by using the unregistration threshold. In this way, it is possible to reduce a time required for matching/verification in a case where the matching processing to the registered image data is performed by the class classification. For example, if the unregistration threshold is not used, the matching result may not be obtained when the likelihood ratio continues to transition without reaching the class threshold. In the present example embodiment, however, the unregistration threshold is set, and it is therefore possible to obtain such a matching result that the image data are unregistered even when the likelihood ratio does not reach the class threshold. By using the unregistration threshold set in the time direction illustrated in FIG. 4 and FIG. 5, it is possible to appropriately adjust a time required to determine that the image data are unregistered. The unregistration threshold may be set in a direction other than the time direction. An example of the unregistration threshold set in a direction other than the time direction will be described in detail in another example embodiment later.

### Second Example Embodiment

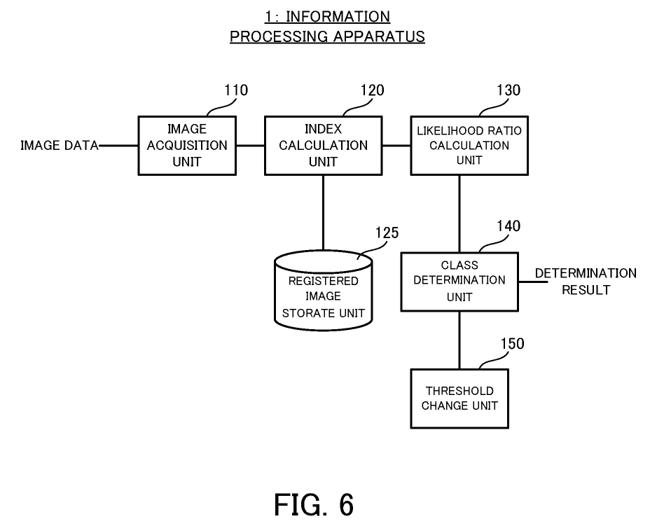

A second information processing apparatus 1 will be described with reference to FIG. 6 to FIG. 10. The second information processing apparatus 1 partially differs from the first information processing apparatus 1 described above in its configuration and operation, and may be the same as the first information processing apparatus 1 in the other parts. For this reason, a part differing from the first example embodiment already described will be described in detail below, and a description of the other overlapping parts will be omitted as appropriate.

### Functional Configuration

First, with reference to FIG. 6, a functional configuration of the second information processing apparatus 1 will be described. FIG. 6 is a block diagram illustrating the functional configuration of the second information processing apparatus. In FIG. 6, the same components as those described in FIG. 2 carry the same reference numerals.

In FIG. 6, the second information processing apparatus 1 includes, as components for realizing its functions, the image acquisition unit 110, the index calculation unit 120, the registered image storage unit 125, the likelihood ratio calculation unit 130, the class determination unit 140, and a threshold change unit 150. That is, the second information processing apparatus 1 further includes the threshold change unit 150 in addition to the configuration described in the first example embodiment (see FIG. 2). The threshold change unit 150 may be a processing block realized by the above-mentioned processor 11 (see FIG. 1).

The threshold change unit 150 is configured to change the unregistration threshold to be used by the class determination unit 140. For example, the threshold change unit 150 may change the unregistration threshold set in the time direction to a value corresponding to an earlier time or to a value corresponding to a later time. The threshold change unit 150 may determine in which direction and to what extent the unregistration threshold is to be changed, based on various types of information inputted to the second information processing apparatus. For example, the threshold change unit 150 may change the unregistration threshold in response to a user input. Alternatively, the threshold change unit 150 may change the unregistration threshold, based on the inputted time-series image data. More specifically, the threshold change unit 150 may change the unregistration threshold depending on the likelihood ratio calculated from the time-series image data or a slope (i.e., a rate of change) of the likelihood ratio. For example, the threshold change unit 150 may change the unregistration threshold by using a function including the likelihood ratio calculated immediately before or the slope of the likelihood ratio. Furthermore, the threshold change unit 150 may dynamically change the unregistration threshold in a case where the time-series image data are sequentially acquired. For example, the threshold change unit 150 may change the unregistration threshold at each time when new image data are acquired. The threshold change unit 150 may further change the class threshold in addition to the unregistration threshold. In this case, the threshold change unit 150 may change the unregistration threshold and the class threshold in association with each other. At that time, a predetermined function may be used to associate the unregistration threshold and the class threshold with each other. A threshold change operation performed by the threshold change unit 150 will be described in detail later with a specific example.

### Flow of Operation

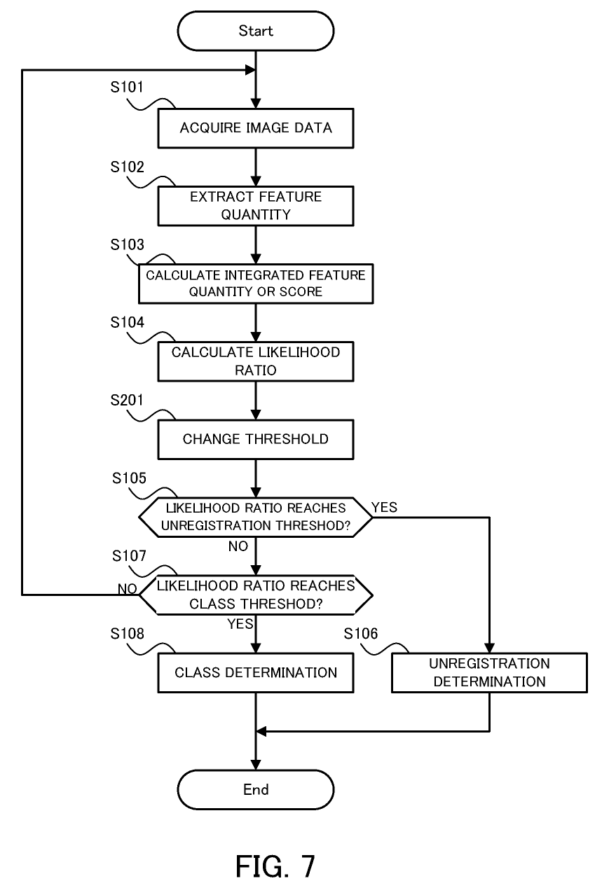

Next, with reference to FIG. 7, a flow of operation of the second information processing apparatus 1 will be described. FIG. 7 is a flowchart illustrating the flow of the operation of the second information processing apparatus. In FIG. 7, the same steps as those described in FIG. 3 carry the same reference numerals.

As illustrated in FIG. 7, when the operation of the second information processing apparatus 1 is started, first, the image acquisition unit 110 acquires the image data (step S101).

Then, the index calculation unit 120 extracts the first feature quantity from the image data acquired by the image acquisition unit 110 and extracts the second feature quantity from the registered image data read from the registered image storage unit 125 (step S102). Then, the index calculation unit 120 calculates the integrated feature quantity or score, based on the extracted first feature quantity and second feature quantity (step S103).

Then, the likelihood ratio calculation unit 130 calculates the likelihood ratio indicating the likelihood of the class to which the time-series image data belong, based on the integrated feature quantity or score calculated by the index calculation unit 120 (step S104).

Then, the threshold change unit 150 changes the unregistration threshold (step S201). The threshold change unit 150 may change the unregistration threshold, for example, based on the likelihood ratio calculated in the step S104 or the slope of the likelihood ratio. Additionally, the threshold change unit 150 may change not only the unregistration threshold, but also the class threshold. Described here is an example of changing the threshold after the likelihood ratio is calculated, but the threshold change unit 150 may change the threshold in different timing. For example, the step S201 may be performed before or after each of the steps S101 to S104 described above. Alternatively, the step S201 may be performed in parallel with each of the steps S101 to S104.

Then, the class determination unit 140 determines whether or not the likelihood ratio calculated by the likelihood ratio calculation unit 130 reaches the unregistration threshold (step S105). Here, the class determination unit 140 uses the unregistration threshold changed by the threshold change unit 150.

In a case where the likelihood ratio reaches the unregistration threshold (step S105: YES), the class determination unit 140 determines that the time-series image data do not belong to any registered class (i.e., they are unregistered) (step S106). In this case, it is determined that the time-series image data do not match the registered image data (in other words, the target is an unregistered user), and the matching processing is ended.

On the other hand, in a case where the likelihood ratio does not reach the unregistration threshold (step S105: NO), the class determination unit 140 determines whether or not the likelihood ratio reaches the class threshold (step S107). In a case where the threshold change unit 150 changes the class threshold, the class determination unit 140 performs the determination by using the changed class threshold.

In a case where the likelihood ratio reaches the class threshold (step S107: YES), the class determination unit 140 determines that the time-series image data belong to the registered class (step S108). In this case, it is determined that the time-series image data match the registered image data (in other words, the target is a registered user), and the matching processing is ended.

On the other hand, in a case where the likelihood ratio does not reach the class threshold (step S107: NO), the processing is started again from the step S101. That is, the image data acquisition unit 110 acquires new image data (e.g., a next frame of image data), and the aforementioned series of processing steps are performed again.

In the flowchart illustrated in FIG. 7, the unregistration threshold is changed by the threshold change unit 150 at each time w a new image is acquired. However, the threshold change unit 150 may be configured to reduce a frequency at which the unregistration threshold is changed. For example, the threshold change unit 150 may be configured to change the threshold every several frames (e.g., every 5 frames). Alternatively, the threshold change unit 150 may be configured to change the threshold at intervals of a predetermined period (e.g., several seconds or several tens of seconds). In addition, the threshold change unit 150 may change the threshold only once at the beginning, and may not change the threshold thereafter. In this case, the threshold change unit 150 may change the threshold when the matching processing for a current target is ended and the matching processing for a new target is started.

### Operation Example

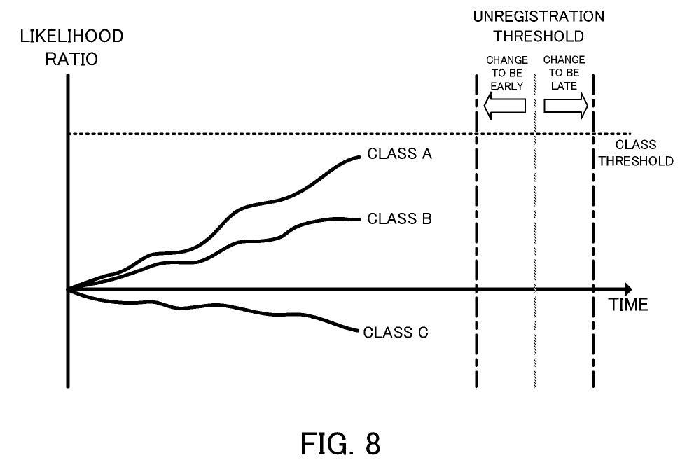

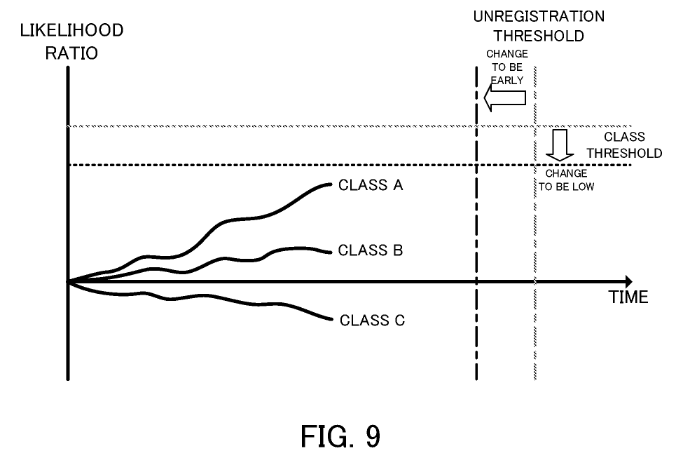

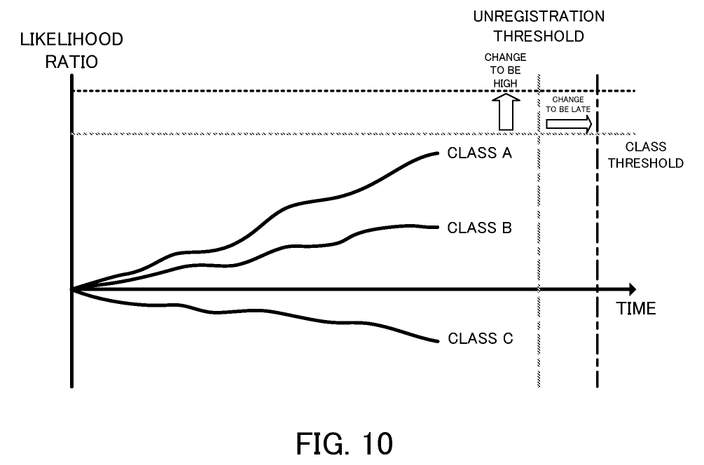

Next, with reference to FIG. 8 to FIG. 10, a specific operation example of the second information processing apparatus 1 (in particular, an example of an operation of changing the threshold used for determining the class) will be described. FIG. 8 is a graph illustrating an example of changing the unregistration threshold in the second information processing apparatus. FIG. 9 is version 1 of a graph illustrating an example of changing the unregistration threshold and the class threshold in the second information processing apparatus. FIG. 10 is version 2 of a graph illustrating an example of changing the unregistration threshold and the class threshold in the second information processing apparatus.

In the examples illustrated in FIG. 8 to FIG. 10, as in the examples illustrated in FIG. 4 and FIG. 5, the registered image data A, the registered image data B, and the registered image data C are registered as the registered image data. Furthermore, the registered classes A, B, and C are set as the registered classes respectively corresponding to the registered image data A, B, and C.

In the example illustrated in FIG. 8, the threshold change unit 150 changes the unregistration threshold set in the time direction. Specifically, the threshold change unit 150 changes the unregistration threshold in a direction to be early (i.e., toward the left in the figure). In this case, since it takes less time to determine that the time-series image data not reaching the class threshold are unregistered, a time required to obtain the matching result is reduced. Therefore, a speed of the matching processing may be improved. Alternatively, the threshold adjustment unit 150 changes the unregistration threshold in a direction to be late (i.e., toward the right in the figure). In this case, since it takes more time to determine that the time-series image data not reaching the class threshold are unregistered, the matching processing requires more time. It is therefore possible to improve the accuracy of the matching processing.

In the example illustrated in FIG. 9, the threshold change unit 150 changes the unregistration threshold in a direction to be early (i.e., toward the left in the figure). In addition, the threshold change unit 150 changes the class threshold to have a lower value (i.e., downward in the figure). In this case, it takes more time to determine that the time-series image data not reaching the class threshold are unregistered, while the likelihood ratio is more likely to reach the class threshold. Therefore, in a case where a time required for the likelihood ratio to reach the class threshold is likely to be longer, it is possible to reduce the time required to obtain the matching result. The threshold change unit may perform the operation illustrated in FIG. 9, for example, in a case where the likelihood ratio has a low value (e.g., in a case where a difference between the likelihood ratio and the class threshold is greater than or equal to a predetermined value), or in a case where the slope of the likelihood ratio is gentle (e.g., in a case where a variation range of the likelihood ratio in a predetermined frame is within a predetermined range).

In the example illustrated in FIG. 10, the threshold change unit 150 changes the unregistration threshold in a direction to be late (i.e., toward the right in the figure). The threshold change unit 150 also changes the class threshold to have a higher value (i.e., upward in the figure). In this case, it takes more time to determine that the time-series image data not reaching the class threshold are unregistered, while the likelihood ratio is less likely to reach the class threshold. Therefore, in a case where the time required for the likelihood ratio to reach the class threshold is likely to be shorter, it is possible to take more time to increase the accuracy of the matching processing. The threshold change unit may perform the operation illustrated in FIG. 10, for example, in a case where the likelihood ratio has a high value (e.g., in a case where the difference between the likelihood ratio and the class threshold is less than the predetermined value), or in a case where the slope of the likelihood ratio is steep (e.g., in a case where the variation range of the likelihood ratio in the predetermined frame is out of the predetermined range).

### Technical Effect

Next, a technical effect obtained by the second information processing apparatus 1 will be described.

As described in FIG. 6 to FIG. 10, the unregistration threshold is changed in the second information processing apparatus 1. In this manner, the class classification may be performed more appropriately than in a case where the unregistration threshold is fixed. For example, this prevents the class classification from taking too much time (i.e., it takes too long to determine that the image data are unregistered) due to the unregistration threshold being set at a time that is too late. Additionally, this prevents such a determination that the image data are unregistered even though the image data are actually registered (i.e., erroneous determination) due to the unregistration threshold being set at a time that is too early.

As illustrated in FIG. 9 and FIG. 10, by changing the unregistration threshold and the class threshold in association with each other, it is possible to perform the class classification more appropriately than in a case where only the unregistration threshold is changed (i.e., in a case where the class threshold is fixed). Furthermore, by changing the threshold based on the value of the likelihood ratio calculated by the likelihood ratio calculation unit 130 or the slope of the likelihood ratio, it is possible to perform the class classification more appropriately in consideration of a current situation.

### Third Example Embodiment

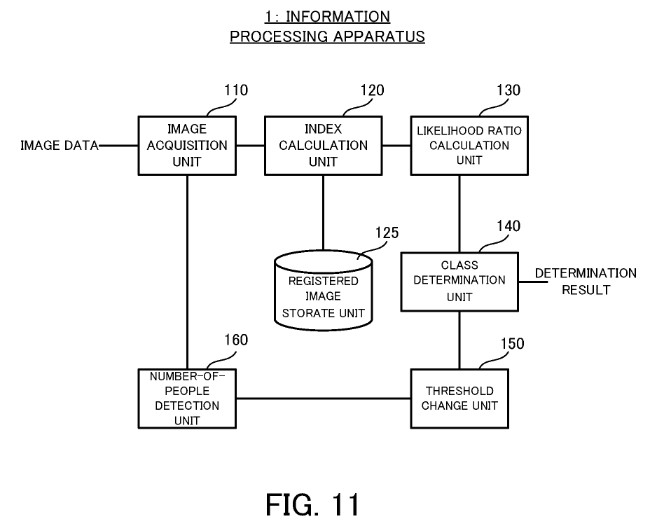

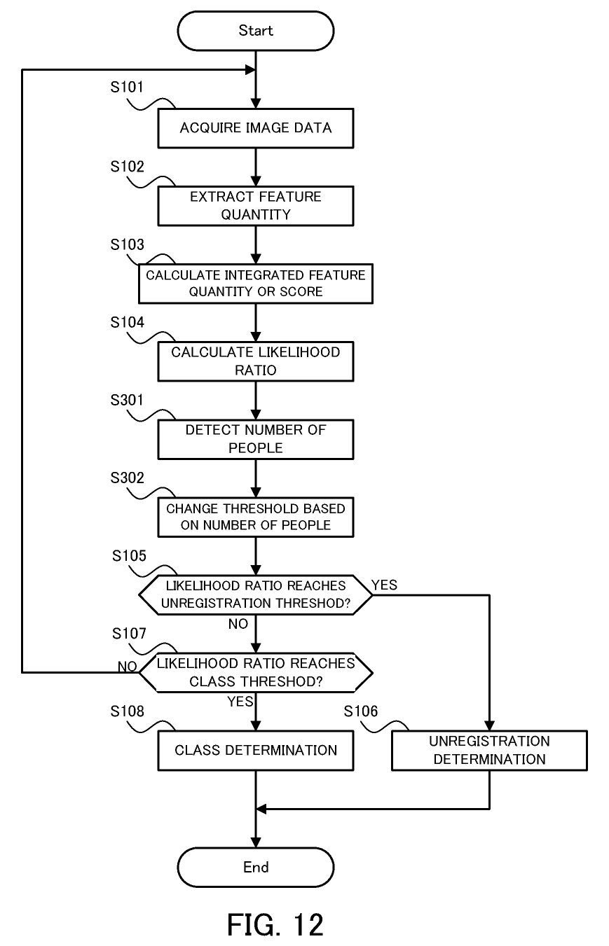

A third information processing apparatus 1 will be described with reference to FIG. 11 and FIG. 12. The third information processing apparatus 1 partially differs from the first and second information processing apparatus 1 described above in its configuration and operation, and may be the same as the first and second information processing apparatus 1 in the other parts. For this reason, a part differing from each of the example embodiments described above will be described in detail below, and a description of the other overlapping parts will be omitted as appropriate.

### Functional Configuration

First, with reference to FIG. 11, a functional configuration of the third information processing apparatus 1 will be described. FIG. 11 is a block diagram illustrating the functional configuration of the third information processing apparatus. In FIG. 11, the same components as those described in FIG. 6 carry the same reference numerals.

In FIG. 11, the third information processing apparatus 1 includes, as components for realizing its functions, the image acquisition unit 110, the index calculation unit 120, the registered image storage unit 125, the likelihood ratio calculation unit 130, the class determination unit 140, the threshold change unit 150, and a number-of-people detection unit 160. That is, the third information processing apparatus 1 further includes the number-of-people detection unit 160 in addition to the configuration described in the second example embodiment (see FIG. 6). The number-of-people detection unit 160 may be a processing block realized by the processor 11 described above (see FIG. 1).

The number-of-people detection unit 160 is configured to detect the number of targets passing through a location where the time-series image data are acquired. For example, the number-of-people detection unit 160 may be configured to detect the number of people passing through an imaging range of a camera that captures the time-series image data (specifically, the number of people captured in an image at the same time, or the number of people passing through the imaging range in a predetermined time). The number-of-people detection unit 160 may detect the number of the targets, based on the time-series image data acquired by the image acquisition unit 110. For example, the number-of-people detection unit 160 may perform processing of detecting the targets captured in the image data and counting the detected targets. Alternatively, the number-of-people detection unit 160 may be configured to count the number of the targets passing through a predetermined area corresponding to the imaging range, by using a sensor that is different from the camera, or the like.

The threshold change unit 150 in the third information processing apparatus 1 changes the threshold, based on the number of the targets detected by the number-of-people detection unit 160 described above. The threshold change unit 150 may change the unregistration threshold in a direction to be early, with increasing number of people detected by the number-of-people detection unit 160. For example, in a case where there are many targets passing through the imaging range of the camera, there may be many targets to be subjected to the class classification (i.e., matching processing), so it is required to speed up the classification of the time-series image data. In such a case, in order to improve the speed of classifying the time-series image data, the unregistration threshold may be changed in a direction to be early as the number of people increases. On the other hand, in a case where there are a small number of targets passing through the imaging range of the camera, there may be a small number of targets to be subjected to the class classification, so it is acceptable that the speed of classifying the time-series image data is somewhat slow. Therefore, the unregistration threshold may be changed in a direction to be late as the number of people decreases.

### Flow of Operation

Next, with reference to FIG. 12, a flow of operation of the third information processing apparatus 1 will be described. FIG. 12 is a flowchart illustrating the flow of the operation of the third information processing apparatus. In FIG. 12, the same steps as those illustrated in FIG. 3 carry the same reference numerals.

As illustrated in FIG. 12, when the operation of the third information processing apparatus 1 is started, first, the image acquisition unit 110 acquires the image data (step S101).

Then, the index calculation unit 120 extracts the first feature quantity from the image data acquired by the image acquisition unit 110 and extracts the second feature quantity from the registered image data read from the registered image storage unit 125 (step S102). Then, the index calculation unit 120 calculates the integrated feature quantity or score, based on the extracted first feature quantity and second feature quantity (step S103).

Then, the likelihood ratio calculation unit 130 calculates the likelihood ratio indicating the likelihood of the class to which the time-series image data belong, based on the integrated feature quantity or score calculated by the index calculation unit 120 (step S104).

Then, the number-of-people detection unit 160 detects the number of the targets passing through the location where the time-series image data are acquired (step S301). Then, the threshold change unit 150 changes the unregistration threshold, based on the number of people detected by the number-of-people detection unit 160 (step S201). Additionally, the threshold change unit 150 may change not only the unregistration threshold, but also the class threshold. Described here is an example of detecting the number of people after the likelihood ratio is calculated, but the number-of-people detection unit 160 may detect the number of people in different timing. For example, the steps S301 and S302 may be performed before or after each of the steps S101 to S104 described above. Alternatively, the steps S301 and S302 may be performed in parallel with each of the steps S101 to S104.

Then, the class determination unit 140 determines whether or not the likelihood ratio calculated by the likelihood ratio calculation unit 130 reaches the unregistration threshold (step S105). Here, the class determination unit 140 uses the unregistration threshold changed by the threshold change unit 150 (more specifically, the unregistration threshold changed based on the number of people detected by the number-of-people detection unit 160).

In a case where the likelihood ratio reaches the unregistration threshold (step S105: YES), the class determination unit 140 determines that the time-series image data do not belong to any registered class (i.e., they are unregistered) (step S106). In this case, it is determined that the time-series image data do not match the registered image data (in other words, the target is an unregistered user), and the matching processing is ended.

On the other hand, in a case where the likelihood ratio does not reach the unregistration threshold (step S105: NO), the class determination unit 140 determines whether or not the likelihood ratio reaches the class threshold (step S107). In a case where the threshold change unit 150 changes the class threshold, the class determination unit 140 performs the determination by using the changed class threshold.

In a case where the likelihood ratio reaches the class threshold (step S107: YES), the class determination unit 140 determines that the time-series image data belong to the registered class (step S108). In this case, it is determined that the time-series image data match the registered image data (in other words, the target is a registered user), and the matching processing is ended.

On the other hand, in a case where the likelihood ratio does not reach the class threshold (step S107: NO), the processing is started again from the step S101. That is, the image data acquisition unit 110 acquires new image data (e.g., a next frame of image data), and the aforementioned series of processing steps are performed again.

### Technical Effect

Next, a technical effect obtained by the third information processing apparatus 1 is described.

As described in FIG. 11 and FIG. 12, in the third information processing apparatus 1, the unregistration threshold is changed based on the number of the targets passing through the location where the time-series image data are acquired. In this way, it is possible to perform the class classification appropriately according to a situation in which the image data are acquired. For example, in a case where there are many targets and quick class classification is required, it is possible to reduce the time required to determine that the image data are unregistered, thereby reducing a time required to obtain a result. In addition, in a case where there are less targets and the class classification can be performed over a period of time, it is possible to increase the time required to determine that the image data are unregistered, thereby improving the accuracy of the determination result.

Described here is a configuration in which the threshold is changed depending on the number of the targets, but the threshold change unit 150 may be configured to change the threshold depending on various factors that affect the class classification (e.g., an operating environment, etc.). For example, in a case where the target quickly moves out of the imaging range of the camera that captures the time-series image data, it is required to speed up the classification of the time-series image data. In such a case, by changing the unregistration threshold in a direction for advising it in time as the target moves out of the imaging range in a shorter time, it is possible to reduce the time required to determine that the image data are unregistered, thereby improving the speed of the class classification. On the other hand, in a case where the target remains in the imaging range of the camera for a long time, it is acceptable that the speed of classifying the time-series image data is somewhat slow. Therefore, by changing the unregistration threshold in a direction to be late as the target remains in the imaging range increases for a longer time, it is possible to increase the time required to determine that the image data are unregistered, thereby improving the accuracy of the class classification.

### Fourth Example Embodiment

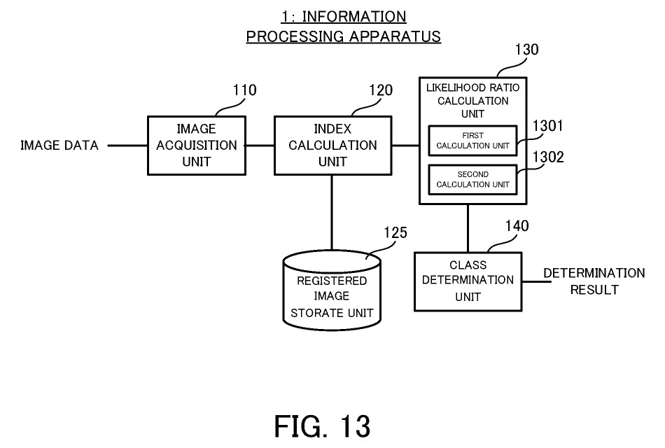

A fourth information processing apparatus 1 will be described with reference to FIG. 13 to FIG. 16. The fourth information processing apparatus 1 partially differs from the first to third information processing apparatuses 1 described above in its configuration and operation, and may be the same as the first to third information processing apparatuses 1 in the other parts. For this reason, a part differing from each of the example embodiments described above will be described in detail below, and a description of the other overlapping parts will be omitted as appropriate.

### Functional Configuration

First, with reference to FIG. 13, a functional configuration of the fourth information processing apparatus 1 will be described. FIG. 13 is a block diagram illustrating the functional configuration of the fourth information processing apparatus. In FIG. 13, the same components as those illustrated in FIG. 2 carry the same reference numerals.

In FIG. 13, the fourth information processing apparatus 1 includes, as components for realizing its functions, the image acquisition unit 110, the index calculation unit 120, the registered image storage unit 125, the likelihood ratio calculation unit 130, and the class determination unit 140. In particular, the likelihood ratio calculation unit 130 in the fourth information processing apparatus 1 is provided with a first calculation unit 1301 and a second calculation unit 1302.

The first calculation unit 1301 is configured to calculate a first likelihood ratio. The first likelihood ratio is the same as the likelihood ratio calculated in the first to third example embodiments already described, and is a value indicating the likelihood that the time-series image data belong to the registered class (i.e., the class corresponding to the registered image data). In a case where there are N registered classes, the first calculation unit 1301 may calculate N first likelihood ratios.

The second calculation unit 1302 is configured to calculate a second likelihood ratio. The second likelihood ratio is a value indicating the likelihood that the time-series image data belong to an unregistered class. Here, the unregistered class refers to a class to which the time-series image data belong, in a case where the time-series image data do not belong to any registered class (i.e., in a case where they are unregistered). Even when there are N registered classes, the second calculation unit 1302 may calculate one second likelihood ratio. In this case, the likelihood ratio calculation unit 130 as a whole calculates (N+1) likelihood ratios.

As described above, in the fourth information processing apparatus 1, in addition to the registered class, the unregistered class is set as a classification candidate for the time-series image data. Then, the class determination section 140 in the fourth information processing apparatus 1 determines to which of the registered classes or to the unregistered class the time-series image data belong. Specifically, the class determination section 140 determines that the time-series image data belong to the registered class (i.e., match the registered image data corresponding to the registered class) in a case where the first likelihood ratio reaches the class threshold. On the other hand, the class determination unit 140 determines that the time-series image data belong to the unregistered class (i.e., are unregistered) in a case where the second likelihood ratio reaches the unregistration threshold before the first likelihood ratio reaches the class threshold.

In the fourth information processing apparatus 1, in a case where the likelihood ratio is calculated by using a machine-learned model, a class used for learning and a class used for operation need to be the same. Therefore, in a case of performing an operation of adding the registered classes as needed (i.e., an operation of adding the registered image data after learning), it is desirable to perform re-learning at each time of a change in the number of classes. Alternatively, it is desirable to use the unregistration threshold set in the time direction, as described in the first to third example embodiments.

### Flow of Operation

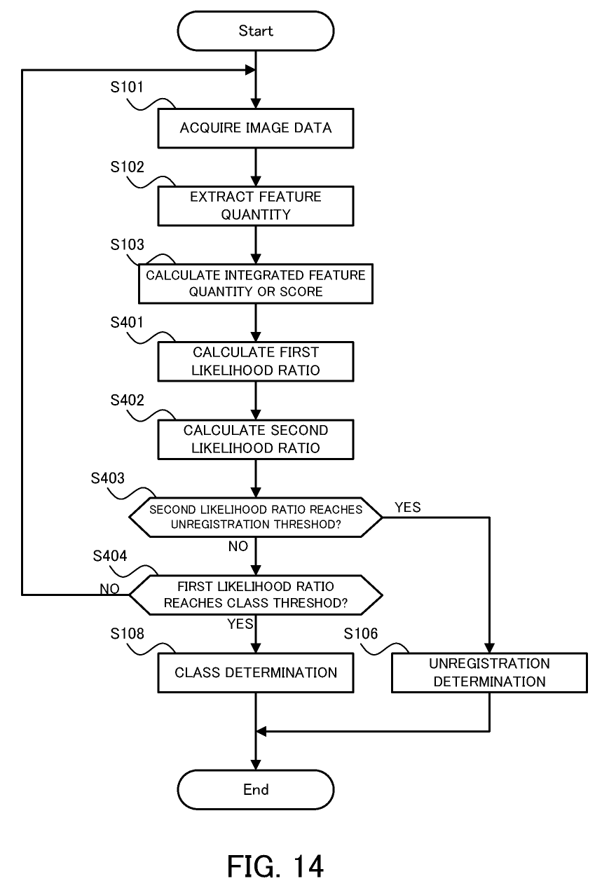

Next, with reference to FIG. 14, a flow of operation of the fourth information processing apparatus 1 will be described. FIG. 14 is a flowchart illustrating the flow of the operation of the fourth information processing apparatus. In FIG. 14, the same steps as those described in FIG. 3 carry the same reference numerals.

As illustrated in FIG. 14, when the operation of the fourth information processing apparatus 1 is started, first, the image acquisition unit 110 acquires the image data (step S101).

Then, the index calculation unit 120 extracts the first feature quantity from the image data acquired by the image acquisition unit 110 and extracts the second feature quantity from the registered image data read from the registered image storage unit 125 (step S102). Then, the index calculation unit 120 calculates the integrated feature quantity or score, based on the extracted first feature quantity and second feature quantity (step S103).

Then, the first calculation unit 1301 calculates the first likelihood ratio indicating the likelihood that the time-series image data belong to the registered class (step S401). Furthermore, the second calculation unit 1302 calculates the second likelihood ratio indicating the likelihood that the time-series image data belong to the unregistered class (step S402). The step S401 and the step S402 may be performed in either order, or simultaneously in parallel.

Then, the class determination unit 140 determines whether or not the second likelihood ratio calculated by the second calculation unit 1302 reaches the unregistration threshold (step S403). In a case where the second likelihood ratio reaches the unregistration threshold (step S403: YES), the class determination unit 140 determines that the time-series image data belong to the unregistered class. That is, the class determination unit determines that the time-series image data do not belong to any registered class (i.e., they are unregistered) (step S106). In this case, it is determined that the time-series image data do not match the registered image data (in other words, the target is an unregistered user), and the matching processing is ended.

On the other hand, in a case where the second likelihood ratio does not reach the unregistration threshold (step S403: NO), the class determination unit 140 determines whether or not the first likelihood ratio calculated by the first calculation unit 1301 reaches the class threshold (step S404). In a case where the first likelihood ratio reaches the class threshold (step S404: YES), the class determination section 140 determines that the time-series image data belong to the registered class (step S108). In this case, it is determined that the time-series image data match the registered image data (in other words, the target is a registered user), and the matching processing is ended.

On the other hand, in a case where the first likelihood ratio does not reach the class threshold (step S404: NO), the processing is started again from the step S101. That is, the image data acquisition unit 110 acquires new image data (e.g., a next frame of image data), and the aforementioned series of processing steps are performed again.

### Operation Example

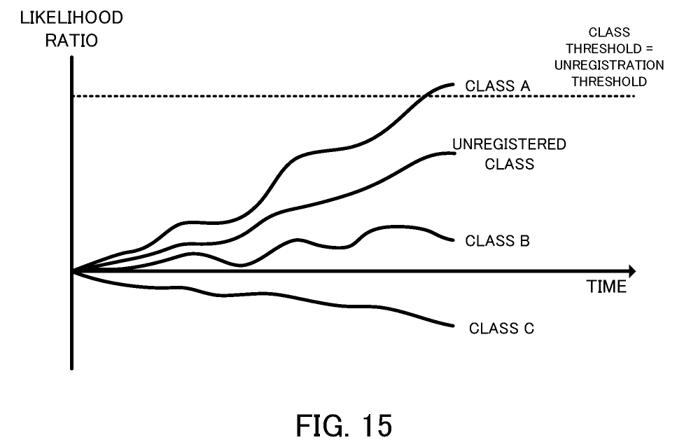

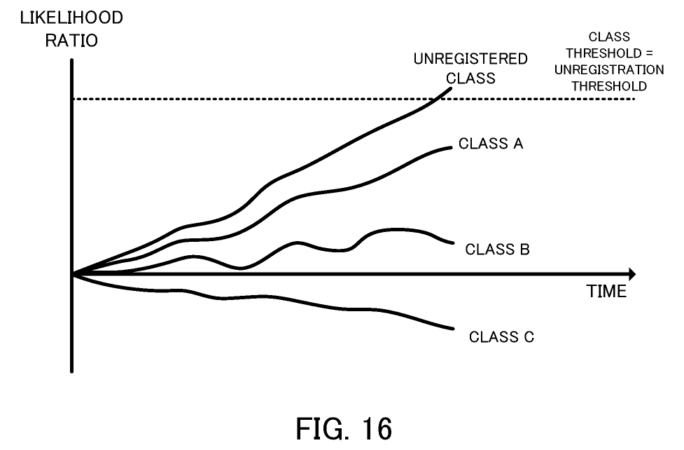

Next, with reference to FIG. 15 and FIG. 16, a specific operation example of the fourth information processing apparatus 1 (in particular, an example of an operation of determining the class to which the time-series image data belong based on the likelihood ratio) will be described. FIG. 15 is version 1 of a graph illustrating an example of the likelihood ratio calculated by the first information processing apparatus. FIG. 16 is version 2 of a graph illustrating an example of the likelihood ratio calculated by the first information processing apparatus.

In the examples illustrated in FIG. 15 and FIG. 16, as in the examples illustrated in FIG. 4 and FIG. 5 and the examples illustrated in FIG. 8 to FIG. 10, the registered image data A, the registered image data B, and the registered image data C are registered as the registered image data. Furthermore, the registered classes A, B, and C are set as the registered classes respectively corresponding to the registered image data A, B, and C.

Especially in the examples illustrated in FIG. 15 and FIG. 16, the unregistered class is set and the time-series image data belong to the unregistered class in a case where the time-series image data do not belong to any one of the classes A, B, and C. Therefore, the likelihood ratio calculation unit 130 calculates three first likelihood ratios respectively corresponding to the classes A, B, and C, and one second likelihood ratio corresponding to the unregistered class. Each of the first likelihood ratios and the second likelihood ratio gradually changes over time (i.e., as the image data are sequentially acquired).

The class threshold is a threshold set in the height direction of the likelihood ratio. Therefore, in a case where the first likelihood ratio that changes over time becomes sufficiently high, it reaches the class threshold. The unregistration threshold is also set in the height direction of the likelihood ratio. Therefore, in a case where the second likelihood ratio that changes over time becomes sufficiently high, it reaches the unregistration threshold. Described here is an example in which the class threshold and the unregistration threshold are set to have the same value, but the class threshold and the unregistration threshold may have different values (i.e., thresholds with different heights).

In the example illustrated in FIG. 15, the first likelihood ratio corresponding to the class A reaches the class threshold. On the other hand, the first likelihood ratios corresponding to the classes B and C do not reach the class threshold. Furthermore, the second likelihood ratio corresponding to the unregistered class does not reach the unregistration threshold. In such a case, the time-series image data acquired by the image acquisition unit 110 are determined to belong to the class A. That is, the time-series image data are determined to match the registered image data A and not to match the registered image data B and C. As a result, obtained is such a matching result that the target included in the time-series image data is a user corresponding to the registered image data A.

In the example illustrated in FIG. 16, none of the first likelihood ratios corresponding to the classes A, B, and C reach the class threshold. On the other hand, the second likelihood ratio corresponding to the unregistered class reaches the unregistration threshold. In such a case, the time-series image data acquired by the image acquisition unit 110 are determined to belong to the unregistered class. In other words, the time-series image data are determined to be unregistered image data that do not belong to any one of the classes A, B, and C. Therefore, the time-series image data are determined not to match any one of the registered image data A, B, and C. As a result, obtained is such a matching result that the target included in the time-series image data is an unregistered user.

### Technical Effect

Next, a technical effect obtained by the fourth information processing apparatus 1 will be described.

As described in FIG. 13 to FIG. 16, in the fourth information processing apparatus 1, it is determined whether or not the time-series image data belong to the unregistered class, thereby determining whether or not the time-series image data are unregistered. In this way, it is possible to reduce the time required for matching/verification in a case where the matching processing to the registered image data is performed by the class classification. For example, if the unregistration threshold is not used, the matching result may not be obtained when the likelihood ratio continues to transition without reaching the class threshold. In the present example embodiment, however, the unregistration threshold is set, and it is therefore possible to obtain such a matching result that the image data are unregistered even when the likelihood ratio does not reach the class threshold.

In addition, the likelihood ratio used for the class classification may be calculated as the first likelihood ratio (i.e., the likelihood ratio indicating the likelihood of the class to which the time-series image data belong) and the second likelihood ratio (i.e., the likelihood ratio indicating the likelihood that the time-series image data belong to the unregistered class), as described above. In this way, it is possible to appropriately perform the class classification and unregistration determination, by using the likelihood ratio corresponding to the registered class and the likelihood ratio corresponding to the unregistered class.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal. The program may be provided to a user in a form of SaaS (Software as a Service), for example.

### Supplementary Notes

The example embodiments described above may be further described as, but not limited to, the following Supplementary Notes below.

### Supplementary Note 1

An information processing apparatus according to Supplementary Note 1 is an information processing apparatus including: an acquisition unit that acquires time-series image data; an index calculation unit that calculates an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; a likelihood ratio calculation unit that calculates a likelihood ratio indicating a likelihood of a class to which the time-series image data belong, based on the integrated feature quantity or the score; and a determination unit that determines that the time-series image data belong to a registered class corresponding to the registered image data in a case where the likelihood ratio reaches a class threshold, and determines that the time-series image data do not belong to any registered class in a case where the likelihood ratio reaches an unregistration threshold without reaching the class threshold.

### Supplementary Note 2

An information processing apparatus according to Supplementary Note 2 is the information processing apparatus according to Supplementary Note 1, wherein the unregistration threshold is a threshold set in a time direction.

### Supplementary Note 3

An information processing apparatus according to Supplementary Note 3 is the information processing apparatus according to Supplementary Note 2, further including a threshold change unit that dynamically changes the unregistration threshold.

### Supplementary Note 4

An information processing apparatus according to Supplementary Note 4 is the information processing apparatus according to Supplementary Note 3, wherein the threshold change unit changes the class threshold and the unregistration threshold in association with each other.

### Supplementary Note 5

An information processing apparatus according to Supplementary Note 5 is the information processing apparatus according to Supplementary Note 3, wherein the threshold change unit changes the unregistration threshold, based on the likelihood ratio or a slope of the likelihood ratio.

### Supplementary Note 6

An information processing apparatus according to Supplementary Note 6 is the information processing apparatus according to Supplementary Note 3, further including: a detection unit that detects a number of targets passing through a location where the time-series image data are acquired, wherein the threshold change unit changes the unregistration threshold based on the number of the targets.

### Supplementary Note 7

An information processing apparatus according to Supplementary Note 7 is the information processing apparatus according to Supplementary Note 1, wherein an unregistered class is set to which the time-series image data belong in a case where the time-series image data are not registered in advance, and the unregistration threshold is a threshold for determining whether or not the time-series image data belong to the unregistered class.

### Supplementary Note 8

An information processing apparatus according to Supplementary Note 8 is the information processing apparatus according to Supplementary Note 7, wherein the likelihood ratio calculation unit calculates a first likelihood ratio indicating a likelihood that the time-series image data belong to the registered class, and a second likelihood ratio indicating a likelihood that the time-series image data belong to the unregistered class, and the determination unit determines that the time-series image data belong to the unregistered class in a case where second likelihood ratio reaches the unregistration threshold before the first likelihood ratio reaches the class threshold.

### Supplementary Note 9

An information processing method according to Supplementary Note 9 is an information processing method that is executed by at least one computer, the information processing including: acquiring time-series image data; calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; calculating a likelihood ratio indicating a likelihood of a class to which the time-series image data belong, based on the integrated feature quantity or the score; and determining that the time-series image data belong to a registered class corresponding to the registered image data in a case where the likelihood ratio reaches a class threshold, and determining that the time-series image data do not belong to any registered class in a case where the likelihood ratio reaches an unregistration threshold without reaching the class threshold.

### Supplementary Note 10

A computer program according to Supplementary Note 10 is a computer program that allows at least one computer to execute an information processing method, the information processing method including: acquiring time-series image data; calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; calculating a likelihood ratio indicating a likelihood of a class to which the time-series image data belong, based on the integrated feature quantity or the score; and determining that the time-series image data belong to a registered class corresponding to the registered image data in a case where the likelihood ratio reaches a class threshold, and determining that the time-series image data do not belong to any registered class in a case where the likelihood ratio reaches an unregistration threshold without reaching the class threshold.

### Supplementary Note 11

A non-transitory recording medium according to Supplementary Note 11 is a non-transitory recording medium on which a computer program that allows at least one computer to execute an information processing method is recorded, the information processing method including: acquiring time-series image data; calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; calculating a likelihood ratio indicating a likelihood of a class to which the time-series image data belong, based on the integrated feature quantity or the score; and determining that the time-series image data belong to a registered class corresponding to the registered image data in a case where the likelihood ratio reaches a class threshold, and determining that the time-series image data do not belong to any registered class in a case where the likelihood ratio reaches an unregistration threshold without reaching the class threshold.

The present disclosure is not limited to the above-described examples and is allowed to be changed, if desired, without departing from the essence or spirit of the invention which can be read from the claims and the entire specification. An information processing apparatus, an information processing method, a computer program, and a non-transitory recording medium with such changes, are also included in the technical concepts of the present disclosure.

### DESCRIPTION OF REFERENCE NUMERALS

1 Information processing apparatus

11 Processor

12 RAM

13 ROM

14 Storage apparatus

15 Input apparatus

16 Output apparatus

17 Data bus

110 Image acquisition unit

120 Index calculation unit

125 Registered image storage unit

130 Likelihood ratio calculation unit

1301 First calculation unit

1302 Second calculation unit

140 Class determination unit

150 Threshold change unit

160 Number-of-people detection unit

What is claimed is:

1. An information processing apparatus comprising:
at least one memory that is configured to store instructions; and
at least one processor that is configured to execute the instructions to:
acquire time-series image data;
calculate an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity;
calculate a likelihood ratio indicating a likelihood of a class to which the time-series image data belong, based on the integrated feature quantity or the score; and
determine that the time-series image data belong to a registered class corresponding to the registered image data in a case where the likelihood ratio reaches a class threshold, and determines that the time-series image data do not belong to any registered class in a case where the likelihood ratio reaches an unregistration threshold without reaching the class threshold.

2. The information processing apparatus according to claim 1, wherein the unregistration threshold is a threshold set in a time direction.

3. The information processing apparatus according to claim 2, wherein the at least one processor is configured to execute the instructions to dynamically change the unregistration threshold.

4. The information processing apparatus according to claim 3, wherein the at least one processor is configured to execute the instructions to change the class threshold and the unregistration threshold in association with each other.

5. The information processing apparatus according to claim 3, wherein the at least one processor is configured to execute the instructions to change the unregistration threshold, based on the likelihood ratio or a slope of the likelihood ratio.

6. The information processing apparatus according to claim 3, wherein the at least one processor is configured to execute the instructions to:
detect a number of targets passing through a location where the time-series image data are acquired, wherein
change the unregistration threshold based on the number of the targets.

7. The information processing apparatus according to claim 1, wherein
an unregistered class is set to which the time-series image data belong in a case where the time-series image data are not registered in advance, and
the unregistration threshold is a threshold for determining whether or not the time-series image data belong to the unregistered class.

8. The information processing apparatus according to claim 7, wherein the at least one processor is configured to execute the instructions to
calculate a first likelihood ratio indicating a likelihood that the time-series image data belong to the registered class, and a second likelihood ratio indicating a likelihood that the time-series image data belong to the unregistered class, and
determine that the time-series image data belong to the unregistered class in a case where second likelihood ratio reaches the unregistration threshold before the first likelihood ratio reaches the class threshold.

9. An information processing method that is executed by at least one computer, the information processing comprising:
acquiring time-series image data;
calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity;
calculating a likelihood ratio indicating a likelihood of a class to which the time-series image data belong, based on the integrated feature quantity or the score; and
determining that the time-series image data belong to a registered class corresponding to the registered image data in a case where the likelihood ratio reaches a class threshold, and determining that the time-series image data do not belong to any registered class in a case where the likelihood ratio reaches an unregistration threshold without reaching the class threshold.

10. A non-transitory recording medium on which a computer program that allows at least one computer to execute an information processing method is recorded, the information processing method including:
acquiring time-series image data;
calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity;
calculating a likelihood ratio indicating a likelihood of a class to which the time-series image data belong, based on the integrated feature quantity or the score; and
determining that the time-series image data belong to a registered class corresponding to the registered image data in a case where the likelihood ratio reaches a class threshold, and determining that the time-series image data do not belong to any registered class in a case where the likelihood ratio reaches an unregistration threshold without reaching the class threshold.
